(19) United States
(12) Patent Application Publication
(10) Pub. No.: US 2003/0108003 A1
(43) Pub. Date: Jun. 12, 2003

(54) Universal personal electronic device power-off or other operating mode change enforcement

(75) Inventor: Timothy Alan Dietz, Austin, TX (US)

Correspondence Address: Duke W. Yee, Carstens, Yee & Cahoon, LLP, P.O. Box 802334, Dallas, TX, 75380, US

(73) Assignees: International Business Machines Corporation, Armonk, NY; IBM Corporation

(21) Appl. No.: 09/981,896

(22) Filed: Oct. 18, 2001

(51) Int. Cl. G08C 17/00; H04Q 5/22

(52) U.S. Cl. 370/311; 340/7.33; 340/10.34

(57) ABSTRACT

A method, apparatus, and computer implemented instructions for enforcing power-off or operating mode change in personal electronic devices. The present invention causes a personal electronic device to change to a required operating mode as indicated by a broadcasted signal in a venue that restricts access of personal electronic devices. Additionally, the personal electronic device can reset to a previous operating mode, i.e., the operating mode prior the enforced change upon receipt of an appropriate broadcast signal.

### BACKGROUND OF THE INVENTION

1. Technical Field

The present invention relates to an improved data processing system. In particular, the present invention relates to a method, apparatus, and computer instructions for enforcing power-off or operating mode changes in personal electronic devices.

2. Description of Related Art

Currently, FAA and airline regulations are in place which require passengers to power-off personal devices, such as cell phones, beepers, and laptop computers. The personal devices may cause dangerous situations due to interference created from their use. Airlines rely on passengers to manually power-off the devices during restricted times, which may consist of takeoff, landing, or the entire flight. Additionally, passengers are told when they may power-on these devices, if at all, and what devices they may turn on. Similarly in theaters, restaurants, and other venues where use of certain devices is not sanctioned, device owners are left to comply manually with the rules. The enforcement of this policy is left to the good will of the owners to manually power-off or change the operating mode of the personal device and does nothing to address electronics left in luggage or baggage that may be inaccessible to the owner. Also, an owner of one of these devices may forget to turnoff or mute the device. In theaters, owners of cell phones may forget to power-off or change the operating mode of their cell phone to vibrate or some other non-intrusive mode so that other guests are not disturbed by phone calls during a movie.

Therefore, it would be advantageous to have an improved method, apparatus, and computer instructions for enforcing power-off or operating mode changes to personal devices within various venues where device owners are left to comply manually with the rules.

### SUMMARY OF THE INVENTION

The present invention provides a method, apparatus, and computer implemented instructions for enforcing power-off or operating mode change in personal electronic devices. The present invention causes a personal electronic device to change to a required operating mode as indicated by a broadcasted signal in a venue that restricts access of personal electronic devices. Additionally, the personal electronic device can reset to a previous operating mode, i.e., the operating mode prior the enforced change upon receipt of an appropriate broadcast signal.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in which the present invention may be implemented;

FIG. 3 is a block diagram illustrating a data processing system in which the present invention may be implemented;

FIG. 4 is a block diagram of a client in the form of a personal digital assistant is depicted in which the present invention may be implemented;

FIG. 5 is a block diagram of a method to enforce personal electronic device power-off or other operating mode change in accordance with a preferred embodiment of the present invention;

FIG. 6 is a block diagram providing a more detailed view of a method to enforce personal electronic devices power-off or other operating mode change in accordance with a preferred embodiment of the present invention;

FIG. 7 is a flowchart of the process to maintain the required operating mode for personal electronic devices within a restricted venue in accordance with a preferred embodiment of the present invention;

FIG. 8 is a flowchart of the process for a personal electronic device containing a programmable radio frequency receiver when entering a restricted venue in accordance with a preferred embodiment of the present invention; and

FIG. 9 is a flowchart of the process for a personal electronic device containing a programmable radio frequency receiver when exiting a restricted venue in accordance with a preferred embodiment of the present invention.

### DETAILED DESCRIPTION OF THE PREFERRED EMBODIMENT

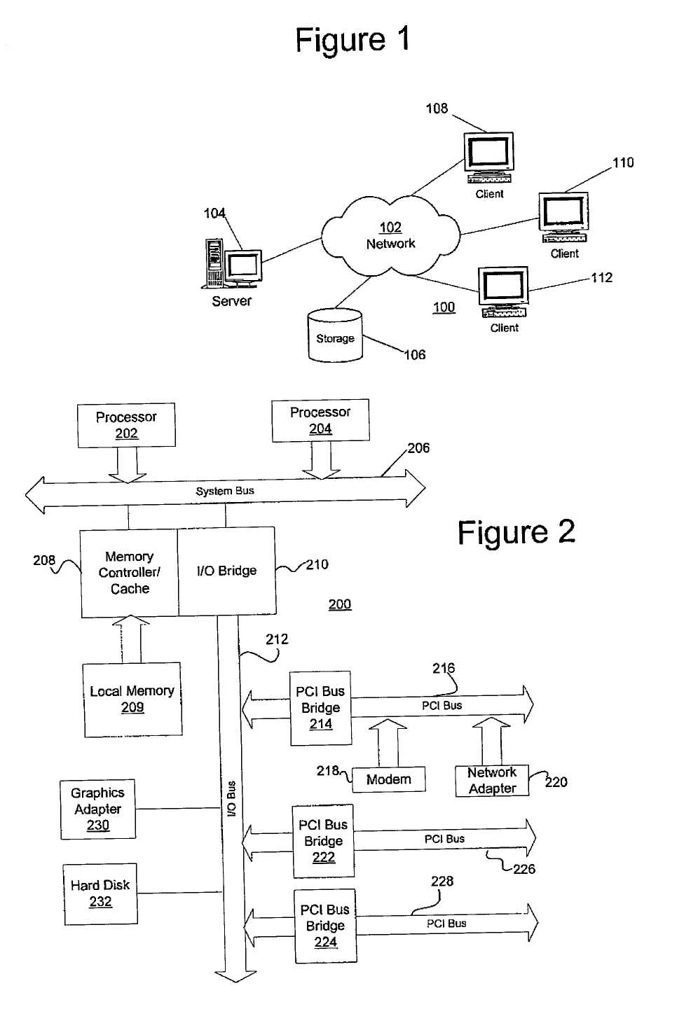

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

Clients 108, 110, 112, and server 104 may have a wireless control system for initiating the powering off or other operating mode changes of wireless devices, such as a personal digital assistant, a cellular phone, or a laptop computer with a wireless modem. These data processing systems may send signals to devices to change the operating mode of the devices when the devices enter or are present in a particular location or venue. For example, with cellular phones, these phones may be automatically turned off when they are present in an aircraft.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), a wide area network (WAN), or a wireless LAN. FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be used to control operating mode changes in devices, such as, for example, powering-off and on devices or placing devices, such as cellular or digital phones into a silent or vibrate mode according the present invention.

Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

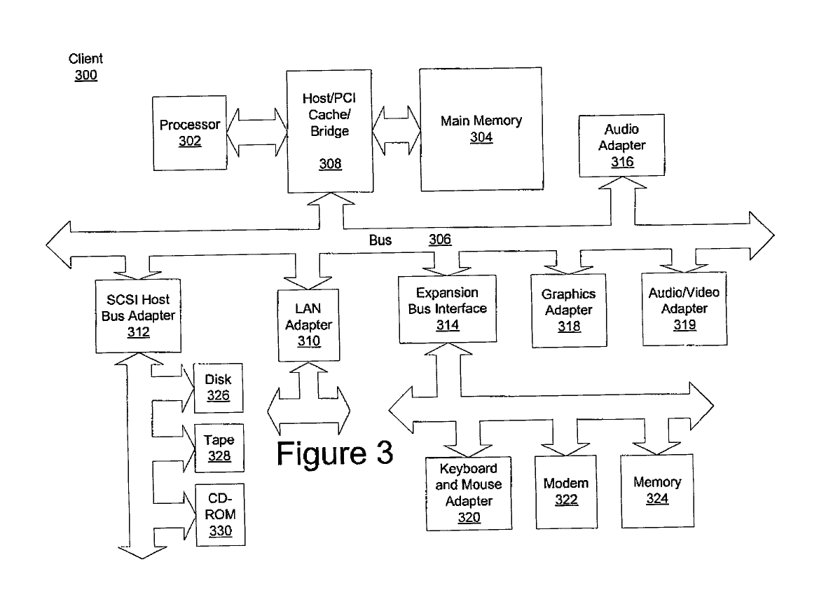

With reference now to FIG. 3, a block diagram illustrating a data processing system is depicted in which the present invention may be implemented. Data processing system 300 is an example of a client computer. Data processing system 300 may be used to control operating mode changes in devices, such as, for example, powering-off and on devices or placing devices, such as cellular or digital phones into a silent or vibrate mode according the present invention. Also, data processing system 300 may be an example of a device that receives signals for operating mode changes. For example, data processing system 300 may be a laptop computer. The operation mode of a device is how the device operates and includes, for example if the device is on, off, in a silent mode, vibrate mode, hibernate mode, the ring or alert used, and whether a display is active. The present invention changes the modes in which a device operates to meet policies in place for different locations.

Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. The depicted example in FIG. 3 and above-described examples are not meant to imply architectural limitations.

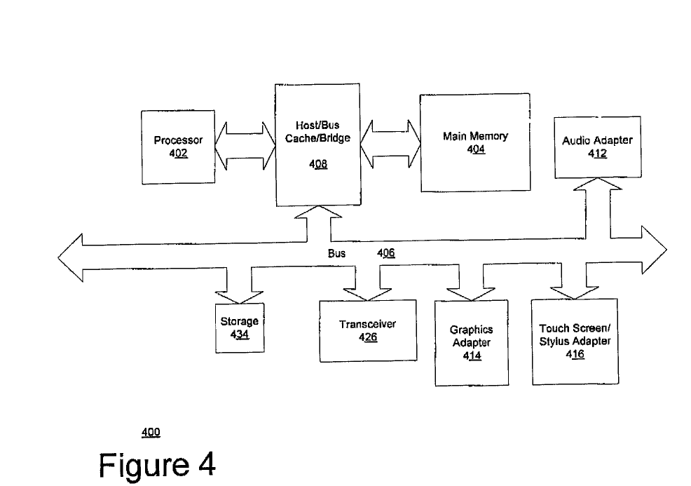

With reference now to FIG. 4, a block diagram of a client in the form of a personal digital assistant (PDA) is depicted in which the present invention may be implemented. PDA 400 is an example of a PDA in which code or instructions implementing the processes of the present invention may be located. In particular, PDA 400 may include instructions to change the operating mode of PDA 400 in response to selected signals or commands. For example PDA 400 may turn off the sound or be powered-off in response to a command or signal to turn off the sounds or power-off. When a device is powered-off or put into a power-off operating mode, the power to the device is turned off.

PDA 400 includes a bus 406 to which processor 402 and main memory 404 are connected through bridge 408. Audio adapter 412, graphics adapter 414, touch screen/stylus adapter 416, transceiver 426, and storage 434 also are connected to bus 406. Further, graphic adapter 412 also includes a mechanism to receive user input from a stylus when a touch screen display is employed.

Transceiver 426 provides a mechanism for a device, such as PDA 400, to be controlled by the control system discussed in FIG. 1.

An operating system runs on processor 402 and is used to coordinate and provide control of various components within PDA 400 in FIG. 4. The operating system may be, for example, a commercially available operating system such as Windows CE, which is available from Microsoft Corporation. Instructions for the operating system and applications or programs are located on storage devices, such as storage 434, and may be loaded into main memory 404 for execution by processor 402.

PDA 400 also preferably includes a graphical user interface that may be implemented by means of systems software residing in computer readable media in operation within PDA 400.

Those of ordinary skill in the art will appreciate that the hardware in FIG. 4 may vary depending on the implementation. Other internal hardware or peripheral devices, such as flash ROM (or equivalent nonvolatile memory) or optical disk drives and the like, may be used in addition to or in place of the hardware depicted in FIG. 4.

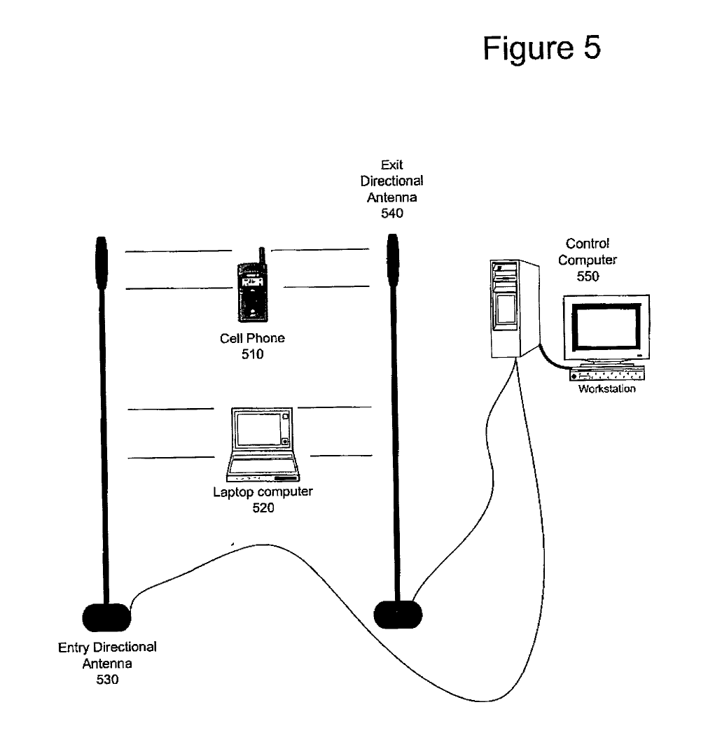

FIG. 5 is a block diagram of a method to enforce personal electronic device power-off or other operating mode change in which the present invention may be implemented. A user with an appropriately equipped device, such as cell phone 510 or laptop computer 520, passes within proximity of a controlled area directional antenna set transmitting a narrow directional signal. Entry directional antenna 530 may be set up in locations such as doorways, hallways, etc., that all persons must pass through to gain access to the premises of a venue with restricted access for personal electronic devices. Entry directional antennas may broadcast a signal that indicates which device capabilities are allowed on the site it controls. If the signal were an 8-bit code, for example, 128 possible combinations of 8 allowable individual functions each represented by a ‘1’ bit could be transmitted, or if each 8 bits coded for a unique function, 128 functions could be controlled by broadcasting multiple 8-bit codes in a short time span to devices equipped to process the signals.

In these examples, the user's device, such as device 510 or 520, is equipped with a receiver that is tuned to the standard frequency of directional operating mode controlling transmitters such as entry directional antenna 530 and exit directional antenna 540. As the device passes within range, it receives the signal relaying the capabilities that are allowed for the given device. The capabilities allowed for different devices may vary. A laptop computer may require a power-off operating mode, which may include the hibernate mode so that data is not lost, and a cell phone may require an operating mode change of vibrate. Upon receiving this signal, the original operating mode of the device is stored and then the operating mode of the device is changed to the broadcasted operating mode required by the premises. The device sends an acknowledgment that the operating mode has been changed as required by the premises.

A general signal to re-enable the user's device is broadcasted from other antennas placed at the exits of the premises, such as exit directional antenna 540. These signals broadcast toward the direction of the outside of the premises. Upon exiting, the user's device receives the signal with its stored original operating mode information and resets itself to the operating mode it was in before passing the first antenna, entry directional antenna 530.

The antennas can be programmed from the attached computer system, such as control computer 550. The control computer allows the enforcement policy to be changed easily. Optional acknowledgment information received from the antennas may be stored in control computer 550. The information may be used to collect historical data, such as the number of cell phone owners who attend movies.

Antennas 530, 540 provide a mechanism used in establishing a wireless communications link between personal electronic devices, such as cellular phone 510 and laptop computer 520, and a network, such as network 102 in FIG. 1.

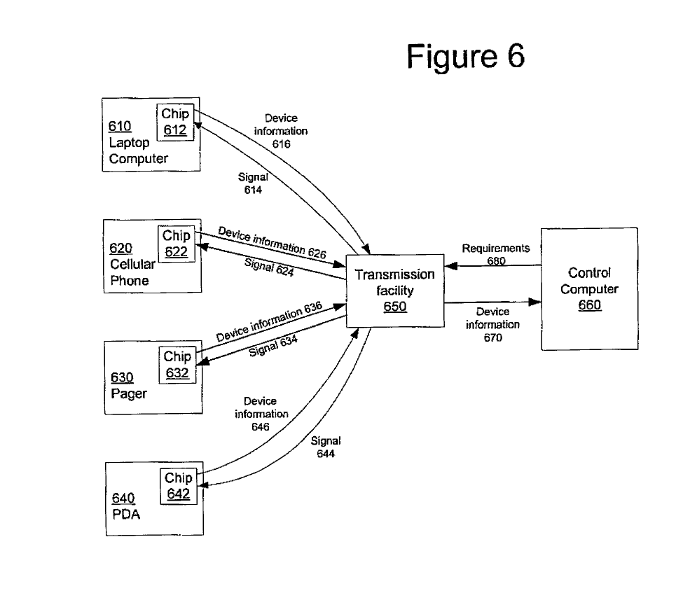

FIG. 6 is a block diagram providing a more detailed view of a method to enforce personal electronic devices power-off or other operating mode changes in which the present invention may be implemented. Signals are broadcasted in a designated area of a location or venue, such as an airport or theater, which requires personal electronic devices, such as laptop 610, cell phone 620, pager 630, and PDA 640, to be powered-off or the operating mode of the device to be changed. An example of a operating mode change that may be desired in a movie theater is to change the mode of a cell phone from ring to vibrate so that people are not disturbed by an incoming call during a movie.

In these examples, the present invention includes a programmable radio frequency receiver, such as chips 612, 622, 632, 642, inside all portable electronic devices, dynamically tuned to a unique matching transmission facility aboard an aircraft or in some other venue, such as a movie theater or a conference room. These chips may be implemented using chips that function as transponders. This function may be implemented in a chip by including a radio-frequency identification system. Personal electronic devices carried through airplane entrances or through the entrances of venues that wish to restrict certain device use on their premises would be dynamically tuned to the unique frequency of the aircraft or other venue. Once tuned, the transmission facility, such as transmission facility 650, could send standard signals 614, 624, 634, 644 to personal electronic devices through the set frequency to power-off or change the operating mode of the device. Transmission facility 650 may be, for example, entry directional antenna 530 and exit directional antenna 540 in FIG. 5.

On an aircraft, additional signals could be sent to power-on their laptop computers back to the previous mode after takeoff, but not to power-on cell phones during a flight. A transponder circuit may be included in chips 612, 622, 632, and 642 so that the power from the signal could be used to turn the device back on. Once a device receives a signal, device information, such as device information 616, 626, 636, 646, may be sent to transmission facility 650. This device information may include a unique device id and an acknowledgment that the signal was received.

A control computer, such as control computer 660, can be used to store device information 670. Control computer 660 may be implemented using a computer, such as for example, data processing system 200 in FIG. 2 or data processing system 300 in FIG. 3. This control computer also may send requirements 680 of the power-off and operating mode change enforcement policies of the aircraft or venue to the transmission facility 650. These policies are used to identify what operating mode changes are required or are being enforced. The policies are used to send the appropriate signals to personal electronic devices, such as laptop 610, cell phone 620, pager 630, and PDA 640. These operating mode changes may be, for example, power-off the devices, move the devices to a silent mode, or to return devices in a silent mode to a previous mode, such as one in which the devices generate sound.

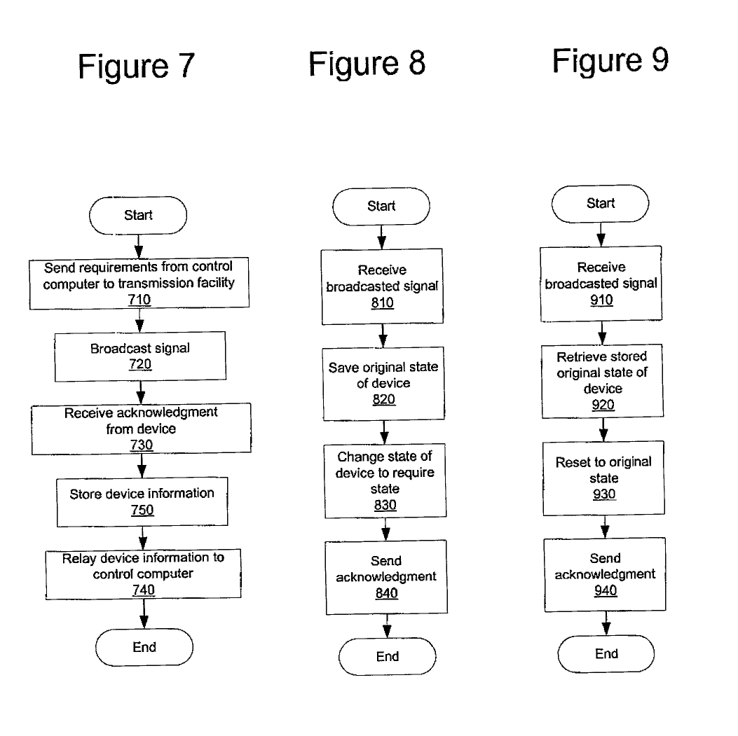

FIG. 7 is a flowchart of the process to maintain the required operating mode for personal electronic devices within a restricted venue in which the present invention may be implemented. These processes may be implemented in a control system such as transmission facility 650 and control computer 660 in FIG. 6.

Various venues have power-off and other operating mode change policies for personal electronic devices. These policies are communicated by specifying the allowable operating modes via the control computer that translates this information into appropriate codes, which are broadcasted via the transmission facility (step 710). The transmission facility broadcasts a signal, which contains the required operating mode coding for given personal electronic devices (step 720). The signal may also indicate that the device re-enabled or reset to the original operating mode. The policy may simply identify the signal that is to be sent to the devices. The transmission facility receives an acknowledgment from the personal electronic device that the signal was received and the operating mode change has been completed (step 730). The transmission facility relays the device information to the control computer (step 740). The control computer stores the device information, such as a unique device id and acknowledgment of the signal, (step 750) with the process ending thereafter.

FIG. 8 is a flowchart of the process for a personal electronic device containing a programmable radio frequency receiver when entering a restricted venue in which the present invention may be implemented. The process illustrated in FIG. 8 may be implemented in a device, such as, for example, cellular phone 620 or pager 630 in FIG. 6.

The programmable radio frequency receiver, or “chip”, receives a broadcasted signal (step 810). The original operating mode of the personal electronic device is saved (step 820). The original operating mode of the personal electronic device may be saved within the device and/or by the control computer. The original operating mode of the personal electronic device is changed to the operating mode required by the venue as indicated by the broadcast signal (step 830). The device then sends an acknowledgment to the transmission facility (step 840) with the process terminating thereafter.

FIG. 9 is a flowchart of the process for a personal electronic device containing a programmable radio frequency receiver when exiting a restricted venue in which the present invention may be implemented. The process illustrated in FIG. 9 may be implemented in a device, such as, for example, cellular phone 620 or pager 630 in FIG. 6.

The chip in the personal electronic device receives a broadcasted signal for the device to reset to the original operating mode prior to entering the restricted venue (step 910). The original operating mode of the device is retrieved (step 920). The device resets itself to its original operating mode (step 930). The device then sends an acknowledgment to the transmission facility (step 940) with the processes terminating thereafter.

Thus, the present invention provides an improved method, apparatus, and computer instructions for controlling operating modes of devices in venues that require devices to have selected operating modes. The present invention provides this advantage by using a change the operating mode of device in the venue. The operating mode may be stored and restored by the mechanism of the present invention. Also, the device may be allowed to change to another operating mode while in the venue. In this manner, selected devices, such as cellular phones, PDAs, and laptop computers may be turned off in an aircraft with a device such as a PDA being turned on after the aircraft has taken off while the cellular phone remains in an off operating mode till the aircraft reaches a gate.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, the mechanism of the present invention may be configured to detect the presence of a device before broadcasting signals to change the operating mode of the device. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a personal electronic device for causing the personal electronic device to change to a required operating mode from an original operating mode, the method comprising:
receiving a broadcasted signal;
saving the original operating mode of the personal electronic device; and
changing the original operating mode of the personal electronic device to the required operating mode as indicated by the broadcasted signal.

2. The method of claim 1, wherein a programmable radio frequency receiver is located inside the personal electronic device.

3. The method of claim 1, wherein the broadcasted signal is a code containing the required operating modes of the personal electronic devices allowed in an area.

4. The method of claim 1, wherein the personal electronic device is a cellular phone, pager, laptop computer, or personal digital assistant.

5. The method of claim 1, wherein the operating mode change includes powering off the personal electronic device.

6. The method of claim 1, wherein the operating mode change includes altering the mode of the personal electronic device.

7. The method of claim 2, wherein the broadcasted signal is a first broadcasted signal and further comprising:
changing the required operating mode back to the original operating mode in the personal device in response to receiving a second broadcasted signal.

8. A method in a personal electronic device for resetting the personal electronic device to its original operating mode after an enforced change, the method comprising:
receiving a broadcasted signal;
retrieving the original operating mode of the personal electronic device; and
restoring the original operating mode of the personal electronic device as indicated by the broadcasted signal.

9. A method in a data processing system for causing an original operating mode of a personal electronic device to change to a required operating mode, the method comprising:
sending the required operating mode to a transmission facility, wherein the transmission facility broadcasts a signal containing the required operating mode;
receiving an acknowledgment from the personal electronic device; and
storing information from the personal electronic device.

10. A personal electronic device comprising:
a bus system;
a communications unit connected to the bus system; a memory connected to the bus system, wherein the memory includes as set of instructions; and
a processing unit connected to the bus system, wherein the processing unit executes the set of instructions to receive a broadcasted signal; save the original operating mode of the personal electronic device; and change the original operating mode of the personal electronic device to the required operating mode as indicated by the broadcasted signal.

11. A personal electronic device comprising:
a bus system;
a communications unit connected to the bus system;
a memory connected to the bus system, wherein the memory includes as set of instructions; and
a processing unit connected to the bus system, wherein the processing unit executes the set of instructions to receive a broadcasted signal; retrieve the original operating mode of the personal electronic device; and restore the original operating mode of the personal electronic device as indicated by the broadcasted signal.

12. A data processing system comprising:
a bus system;
a communications unit connected to the bus system;
a memory connected to the bus system, wherein the memory includes as set of instructions; and
a processing unit connected to the bus system, wherein the processing unit executes the set of instructions to send the required operating mode to a transmission facility, wherein the transmission facility broadcasts a signal containing the required operating mode; receive an acknowledgment from the personal electronic device; and store information from the personal electronic device.

13. A personal electronic device for causing the personal electronic device to change to a required operating mode from an original operating mode, the personal electronic device comprising:
receiving means for receiving a broadcasted signal;
saving means for saving the original operating mode of the personal electronic device; and
changing means for changing the original operating mode of the personal electronic device to the required operating mode as indicated by the broadcasted signal.

14. A personal electronic device for resetting the personal electronic device to its original operating mode after an enforced change, the personal electronic device comprising:
receiving means for receiving a broadcasted signal;
retrieving means for retrieving the original operating mode of the personal electronic device; and
restoring means for restoring the original operating mode of the personal electronic device as indicated by the broadcasted signal.

15. A data processing system for causing an original operating mode of a personal electronic device to change to a required operating mode, the data processing system comprising:
sending means for sending the required operating mode to a transmission facility, wherein the transmission facility broadcasts a signal containing the required operating mode;
receiving means for receiving an acknowledgment from the personal electronic device; and
storing means for storing information from the personal electronic device.

16. A computer program product in a computer readable medium for causing the personal electronic device to change to a required operating mode from an original operating mode, the computer program product comprising:
first instructions for receiving a broadcasted signal;
second instructions for saving the original operating mode of the personal electronic device; and
third instructions for changing the original operating mode of the personal electronic device to the required operating mode as indicated by the broadcasted signal.

17. A computer program product in a computer readable medium for resetting the personal electronic device to its original operating mode after an enforced change, the computer program product comprising:
first instructions for receiving a broadcasted signal;
second instructions for retrieving the original operating mode of the personal electronic device; and
third instructions for restoring the original operating mode of the personal electronic device as indicated by the broadcasted signal.

18. A computer program product in a computer readable medium for causing an original operating mode of a personal electronic device to change to a required operating mode, the computer program product comprising:
first instructions for sending the required operating mode to a transmission facility, wherein the transmission facility broadcasts a signal containing the required operating mode;
second instructions for receiving an acknowledgment from the personal electronic device; and
third instructions for storing information from the personal electronic device.
